(19) United States
(12) Patent Application Publication
(10) Pub. No.: US 2019/0025515 A1
(43) Pub. Date: Jan. 24, 2019

(54) OPTICAL FIBER SORTING AND FUSION SPLICING SYSTEM AND METHOD

(71) Applicant: CommScope Asia Holdings B.V., DG Bussum (NL)

(72) Inventors: Laurens Izaak VAN WUYCKHUYSE, CL Rosmalen (NL); Paul SCHNEIDER, AH Gemonde (NL); Jan Willem RIETVELD, AM Benschop (NL)

(73) Assignee: CommScope Asia Holdings B.V., DG Bussum (NL)

(21) Appl. No.: 15/755,774

(22) PCT Filed: Aug. 26, 2016
(86) PCT No.: PCT/EP2016/070184

§ 371 Date: Feb. 27, 2018

Related U.S. Application Data
(60) Provisional application No. 62/210,776, filed on Aug. 27, 2015.

(51) Int. Cl. G02B 6/255; G02B 6/25; G02B 6/245

(52) U.S. Cl. CPC G02B 6/2553; G02B 6/245; G02B 6/25

(57) ABSTRACT

A cable sorting and fusion splicing system (100) and method for arranging a plurality of optical fibers (17) in a cable in a predetermined sequence for fusion splicing to a multi-fiber optical connector (42). The cable sorting device 1 automatically sorts a plurality of optical fibers, such as twelve, loosely contained within a cable jacket (20). The fibers (17) are sorted in a predetermined sequence and maintained in a linear arrangement. The linear arrangement of fibers (17) is utilized at a fusion splicing device (40) to fusion splice to a multi-fiber optical connector having a corresponding sequence of optical fibers which are respectively fusion spliced to the optical fibers (17) of the cable. The fusion splicing device (40) is a mass fusion splicer which splices all of the fibers simultaneously.

### CROSS-REFERENCE TO RELATED APPLICATION

This application claims the benefit of U.S. Patent Application Ser. No. 62/210,776, filed on Aug. 27, 2015, the disclosure of which is incorporated herein by reference in its entirety.

### BACKGROUND

Multi-fiber optical connectors and cables are used throughout telecommunications systems, including datacenters. Sometimes ribbon cables are used. There is a need for improvements in the systems and methods for connecting multi-fiber cables to multi-fiber connectors for connecting to equipment. There is also a need for cable systems and termination methods for use in telecommunications systems where space constraints may be a concern.

### SUMMARY

The invention relates to a cable sorting and fusion splicing system and method for arranging a plurality of cables (optical fibers) in a predetermined sequence for fusion splicing to a multi-fiber optical connector. The cable sorting feature automatically sorts a plurality of optical fibers, such as twelve fibers, loosely contained within a cable jacket of a single cable. The optical fibers are sorted into a predetermined sequence and maintained in a linear arrangement. The linear arrangement is utilized to fusion splice to a multi-fiber optical connector having a corresponding sequence of optical fibers which are respectively fusion spliced to the optical fibers of the cable. In one example, the fusion splicer is a mass fusion splicer which splices all of the fibers simultaneously.

### BRIEF DESCRIPTION OF THE FIGURES

FIG. 1 shows a schematic sectional view of an embodiment of a cable sorting device, shown perpendicular to a rotational axis of a cylinder of the device;

FIG. 2 shows a schematic perspective view of a cable sorting device shown along a horizontal cross-section;

FIGS. 3-7 show a series of process steps during feeding of a sorting buffer with a plurality of individual optical fibers of a cable;

FIGS. 8-12 show a series of process steps for extracting optical fibers from a sorting buffer into a congregator slit;

FIG. 13 shows a schematic view of a system including an optical fiber sorting device, a fusion splicing device, and a supply of multi-fiber connectors, with control of the system by a control module;

FIG. 14 shows a flowchart of steps in the processing of an optical fiber cable with loosely held optical fibers (not ribbonized) and a multi-fiber optical connector which is fusion spliced to the optical fibers.

### DETAILED DESCRIPTION

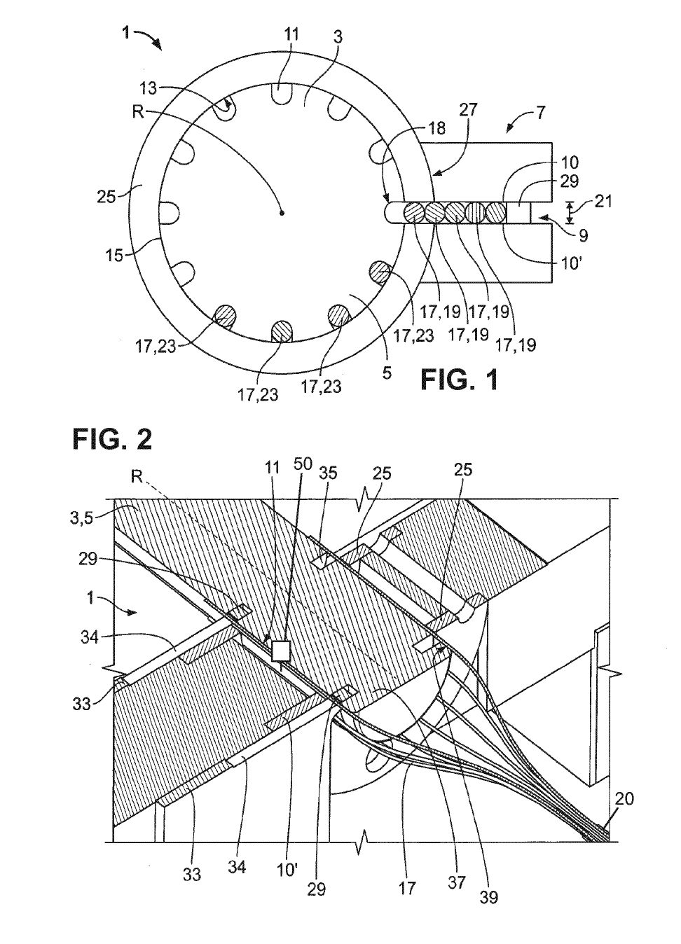

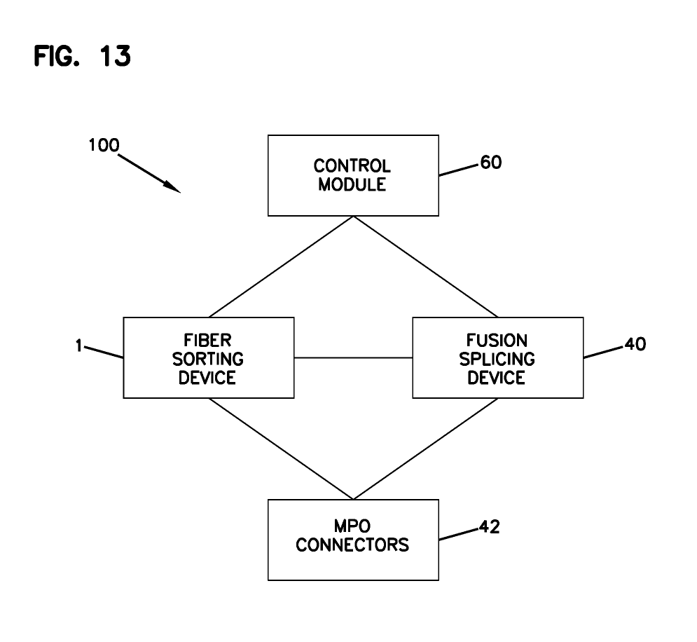

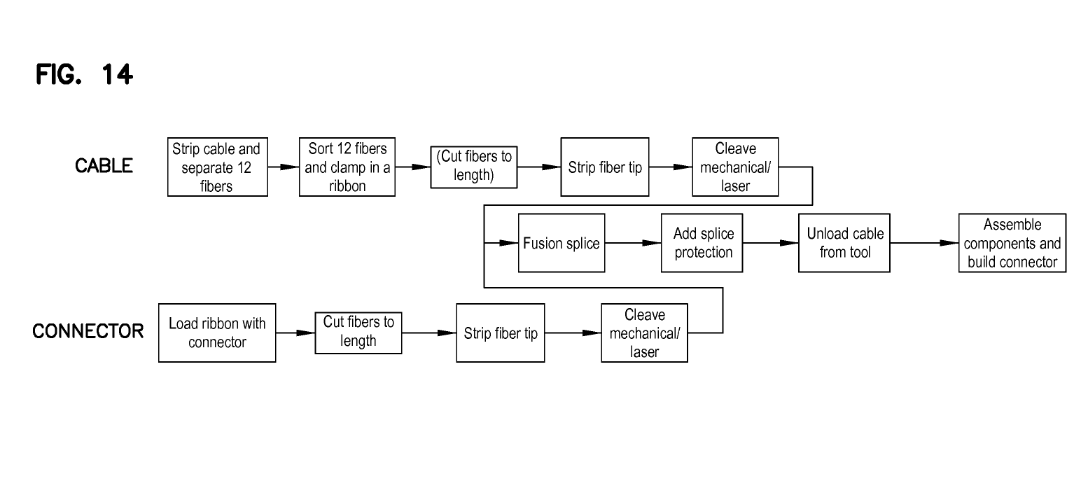

A cable sorting device 1 is shown in FIGS. 1-12 for use in the system and method of sorting cables (fibers) and fusion splicing the cables (fibers) to a multi-fiber connector as described and shown in FIGS. 13 and 14. The device allows for the termination of a cable with multiple optical fibers inside where the optical fibers are loose and are not organized in a particular manner, like in a ribbonized cable.

FIG. 1 shows a schematic view of a cable sorting device 1 for sorting the fibers 17 of a single cable. The view of FIG. 1 is in a perpendicular view to a rotation axis R of a revolving cylinder 3. The revolving cylinder 3 of the device 1 forms a sorting buffer 5. A congregator arrangement or congregator 7 includes a congregator slit 9. The sorting buffer 5 includes a plurality of storage bins 11. The storage bins 11 are opened in a radial direction of the cylinder 3, with the openings 13 facing away from the rotational axis R and being aligned with a cylinder surface 15. One of the storage bins 11 is shown in a transport position 18, with its opening 13 being aligned with the congregator slit 9. The storage bins 11 of the sorting buffer are arranged equally spaced from each other around the cylinder surface 15.

FIG. 1 shows the cable sorting device 1 in an intermediate process step during feeding of the sorting buffer 5 with fibers 17. A portion of the fibers 17 is located in the congregator slit 9. The fibers that are located in the congregator slit 9 are arranged in the transfer position 19. The congregator slit 9 is adapted to align the fibers 17 in a flat and parallel order. The congregator slit 9 comprises slit surfaces 10 and 10′. The fibers 17 that are located in storage bins 11 of the sorting buffer 5 are arranged in a storage position 23. A locking member 25 is arranged around the cylinder 3 to close the storage bins 11, maintaining the cables inside the storage bins 11 during rotational movement of the cylinder 3 relative to the locking member 25. The locking member 25 includes a cover opening 27 allowing the fibers 17 to be transferred between the congregator arrangement 7 and the storage bins 11 in the sorting buffer 5. The locking member 25 may be adapted to form a mechanical bearing for the cylinder 3. During feeding of the sorting buffer 5 with fibers 17, the cable transfer member 29 may press the fibers 17 that are in a transfer position 19 in a direction towards the sorting buffer 5.

FIG. 2 shows a schematic perspective view of the cable sorting device 1 with fibers 17 being located in the storage bins 11 around the cylinder 3 with the cable transfer member 29 being located in an extracting position 31. The storage bins 11 are aligned parallel to the rotation axis R. The cable sorting device 1 may comprise two locking members 25. The locking members 25 may be adapted to bear the cylinder 3 during rotational movement. The cable sorting device 1 may comprise two cable transfer members 29 which are spaced apart from each other along a direction parallel to the rotational axis R. The cable transfer members 29 may be formed as protrusions of the cable transfer arrangements 33, with the cable transfer arrangements 33 supporting the cable transfer members 29 and connecting them to a drive which may comprise at least one motor or actuator. The cable transfer arrangements 33 may comprise a cable support surface 34 which is formed as a recess. The cable support surface 34 may be aligned with the slit surface 10′ when the cable transfer member 29 is in the extracting position 31. The two locking members 25 are spaced apart from each other and are enclosed between the two cable transfer members 29. Alternatively the locking members 25 can be arranged having the cable transfer members 29 between them. The cylinder 3 comprises two transfer recesses 35. The transfer recesses 35 are formed as channels which encircle the cylinder 3 around the rotational axis R. The transfer recesses 35 are adapted to allow the cable transfer members 29 to move into the extracting position 31, in which the cable transfer members 29 penetrate the transfer recesses 35. The cylinder 3 may comprise an aligning head 37, comprising an aligning surface 39 which is adapted to pre-align fibers 17 in order to maintain an uncoiled alignment of the fibers 17 that are located in storage bins 11.

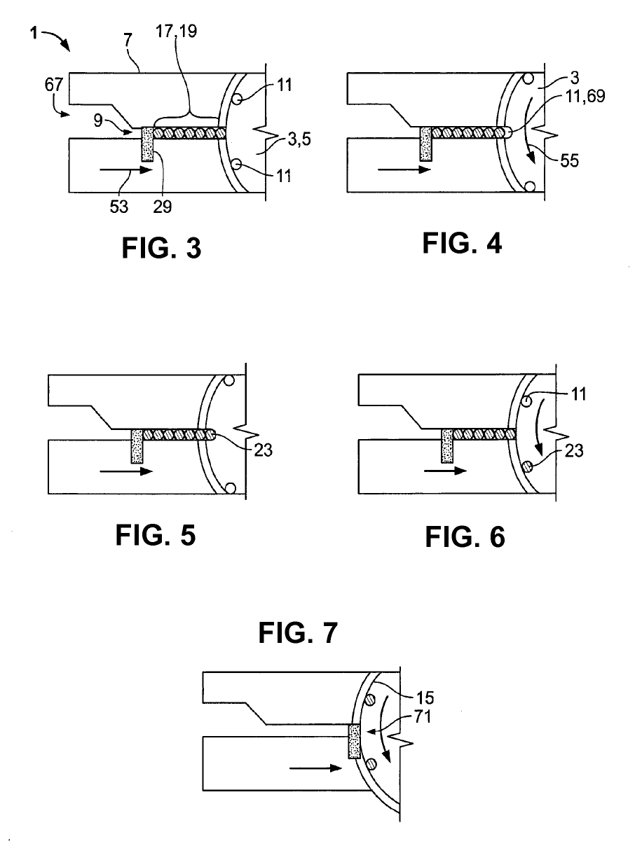

FIGS. 3-7 show a schematic presentation of a transfer process wherein fibers 17 are loaded from congregator slit 9 into the sorting buffer 5 in a feeding direction 53. Congregator slit 9 has an insertion opening 67 to facilitate loading of the fibers 17 initially. The cable sorting device 1 includes a cable sensor 50, which is directed onto the fibers, with the fibers being located in the congregator slit 9 or in the sorting buffer 5, and wherein the cable sensor 50 is adapted to detect a fiber identification characteristic and to transmit a fiber sequence signal to a control module 60. The cable sensor 50 may detect and recognize the individual fibers of a plurality of fibers in order to determine the actual fiber sequence prior to or after the sorting and rearranging process. The control module 60 may preferably comprise a comparator which is adapted to compare the fiber sequence signal to a predetermined target sequence and wherein the control module is operatively connected to a drive, moving at least one of the sorting buffer 5 and the cable transfer member 7. The control module 60 may be fed with a desired target sequence of the fibers. The comparator may compare the actual fiber sequence with the target sequence and may, if the actual sequence differs from the target sequence, operate the drive and control of the sorting and rearranging process. The cable sorting device 1 may include a drive assembly comprising at least one motor and/or at least one actuator, providing the driving force for the relative movement between the cable sorting device and the congregator arrangement. The drive may be connected to an energy source, providing energy for the drive. Cylinder 3 can rotate in one or both of directions 55, 55′.

The cable sorting device 1 may be used to load a linear arrangement of cables in one sequence from the congregator 7 into the sorting buffer 5, and then from the sorting buffer 5 back to the congregator 7, or another congregator, in a different sequence. The cable sorting feature automatically sorts a plurality of optical fibers 17, such as twelve, loosely contained within a cable jacket 20.

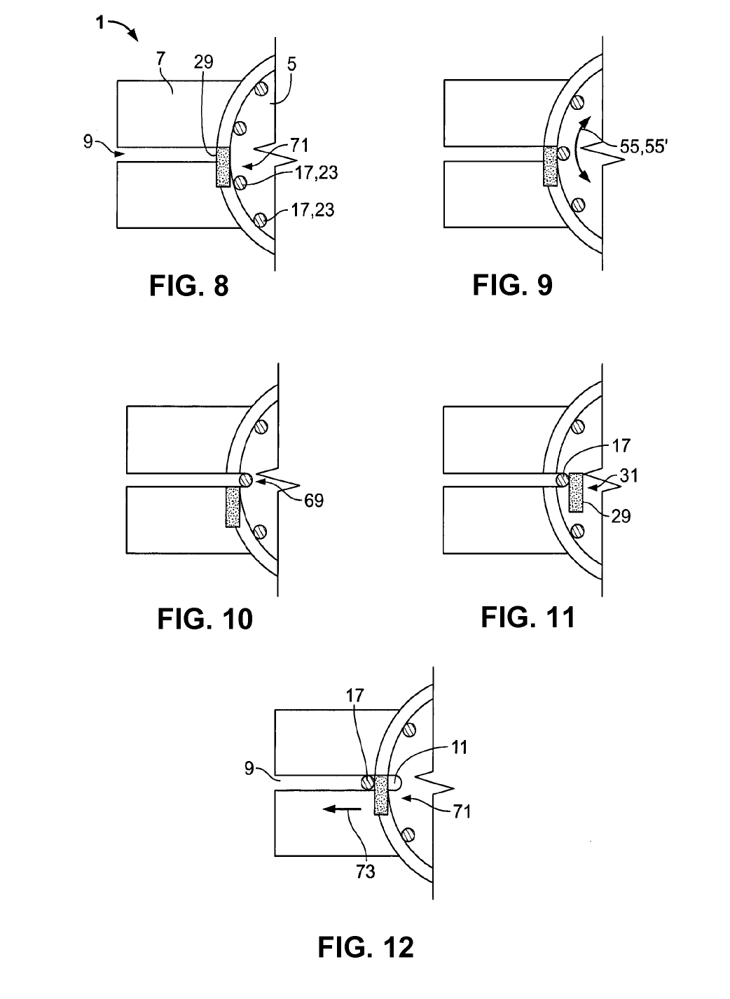

FIGS. 8-12 schematically shows the process of transferring fibers 17 from the sorting buffer 5 in the extraction direction 73 into congregator slit 9 in a predetermined order. Control module 60 controls member 29 to move from the closed position 71 to the extracting position 31. With the predetermined order in the congregator slit 9, the cables are ready for fusion splicing to a multi-fiber connector 42, such as with a fusion splicer 40. One multi-fiber connector is an MPO style. The multi-fiber connector is loaded with fibers before the fusion splicing step. The aligned fibers can be placed into a fiber fixture for holding the fibers of the cable in position for being spliced to the fibers of the multi-fiber connector. No ribbonizing of the loose fiber cable is needed in the preferred applications.

Further features of a cable (fiber) sorting device 1 are shown in EP2787380A1, the disclosure of which is hereby incorporated by reference.

As shown in FIG. 13, the cable (fiber) sorting device 1 and the fusion splicing device 40 can be combined into a single system 100 usable by a technician near to where a cable needs to be terminated to a multi-fiber connector, such as in a data center. With the combined fiber sorting device and the fiber splicing device, fibers inside the cable can be randomly ordered in the cable instead of ribbonized, which results in thinner and more flexible cables in data centers, where space requirements become more stringent. The smaller cables and more flexible cables improve handling within the data center and take up less space inside the racks. Further, there is less need for space for the bending of large cables or cables that require large bending areas. Also, the technician can easily combine the processes of readying the cable for fusion splicing with a fusion splicing device near where the cable will be connected to equipment. Since the cables are automatically sorted into the predetermined order, there is less likelihood of error with a manual sorting. Further, since the sorting is done near the fusion splicing device, the process for cable termination is more efficient.

Referring now to FIG. 14, a flowchart is shown for processing of the cable and processing of the connector wherein the cable and the connector are fusion spliced to result in the termination of a non-ribbonized cable. The above described systems and methods can be used to terminate one or both ends of a multi-fiber cable. The system can include an integrated tool that does both sorting and splicing, or separate tools can be utilized, wherein a technician can more easily terminate to multi-fiber connectors with non-ribbonized cables.

1. A fiber termination system comprising:
a fiber sorting device for automatically sorting a random arrangement of fibers of a cable into a predetermined linear arrangement;
the fiber sorting device including a controller for reading the random arrangement, and moving the fibers into the predetermined linear arrangement;
a fiber fusion splicing device including a multi-fiber connector having the same predetermined linear arrangement of corresponding fibers, and a fusion splicer to splice the fibers of the cable to the corresponding fibers of the multi-fiber connector.

2. The fiber termination system of claim 1, wherein the random arrangement of fibers of the cable comprises a cable with loose fibers disposed within the cable jacket along a length of the cable inside of the cable jacket.

3. The fiber termination system of claim 1, wherein the predetermined linear arrangement of the fibers is clamped in a ribbon shape but not ribbonized with ribbonizing binder before and after being spliced.

4. The fiber termination system of claim 1, wherein the random arrangement of fibers is initially stored in a first linear slot before being sorted.

5. The fiber termination system of claim 1, wherein the predetermined linear arrangement of the fibers is stored in a second linear slot after being sorted.

6. The fiber termination system claim 5, wherein the first linear slot and the second linear slot are the same linear slot.

7. A method of fiber termination of a cable to a connector comprising using the system of claim 1, and further comprising:
cutting the predetermined linear arrangement of fibers to a selected length;
stripping the coating of the cut fibers;
preparing ends of the stripped and cut fibers for splicing;
mass fusion splicing the ends of the stripped and cut fibers to corresponding fibers of the multi-fiber connector having the same predetermined linear arrangement of corresponding fibers.

8. A method of fiber termination of a first multi-fiber cable to a second multi-fiber cable comprising:
automatically sorting a random arrangement of fibers of the first multi-fiber cable into a predetermined linear arrangement with a fiber sorting device;
wherein the fiber sorting device includes a controller for reading the random arrangement, and moving the fibers into the predetermined linear arrangement;
cutting the predetermined linear arrangement of fibers to a selected length;
stripping the coating of the cut fibers;
preparing ends of the stripped and cut fibers for splicing;
mass fusion splicing the ends of the stripped and cut fibers to corresponding fibers of the second multi-fiber cable having the same predetermined linear arrangement of corresponding fibers.

9. The method of claim 8, wherein the second multi-fiber cable is a connectorized cable having a multi-fiber connector at an opposite end of the corresponding fibers.

10. The method of claim 8, wherein the random arrangement of fibers of the first multi-fiber cable comprises a cable with loose fibers disposed within the cable jacket along a length of the cable inside of the cable jacket.

11. The system and method of claim 1, wherein the multi-fiber elements are twelve (12) fiber elements.
